(19) United States
(12) Patent Application Publication
(10) Pub. No.: US 2022/0256225 A1
(43) Pub. Date: Aug. 11, 2022

(54) DIGITAL IMAGE DISPLAY DEVICE

(71) Applicant: Lovneet Singh, Everett, WA (US)

(72) Inventor: Lovneet Singh, Everett, WA (US)

(21) Appl. No.: 17/173,353

(22) Filed: Feb. 11, 2021

(51) Int. Cl. H04N 21/43

(52) U.S. Cl. CPC H04N 21/4302

(57) ABSTRACT

The present invention relates generally to audio and video media communication, storage, display, and processing; and, more particularly, it relates to various methods and systems operable to perform communication, storage, and processing of audio and video media within, among, and between various media operable systems including an integrated cable modem, a network attached storage system, and cable television management system that is operable to receive and manage signals via airwave and satellite broadcast, Internet, and dedicated wireline transmission.

### BACKGROUND OF THE INVENTION

### Description

### 1. Field of the Invention

The present invention relates generally to audio and video media communication, storage, display, and processing; and, more particularly, it relates to various methods and systems operable to perform communication, storage, and processing of audio and video media within, among, and between various media operable systems including an integrated cable modem and cable television management system that is operable to receive and manage signals via airwave and satellite broadcast, Internet, built in media storages, hard drives, memory cards, and dedicated wireline transmission. Additionally, the device may have a media storage and management system built in (e.g. Plex) along with removable and replaceable Hard drives, SSD, usb drives. So that consumer can store their personal data (images, videos) on TV itself and can watch on demand without connecting to any external devices (e.g. airplay) or external services (amazon or google storage). Additional features are a built in modem router and built in storage with data/media management system

### 2. Related Art

Traditional cable television broadcast systems typically include a cable television broadcast center and a television that is operable to receive those broadcast signals. There is typically no communication between the cable television broadcast center and the television other that the receipt of programming of the signal by the television from the cable television broadcast center. Commonly, a user of a television within such a system is limited to the programming that is provided by the cable television broadcast center or streaming media services, such as Netflix, Amazon Prime Video, Disney+, and HULU.

Further limitations and disadvantages of conventional and traditional systems will become apparent to one of skill in the art through comparison of such systems with the present invention as set forth in the remainder of the present application with reference to the drawings.

### SUMMARY OF THE INVENTION

Various aspects of the present invention can be found in an integrated cable modem and cable television management system. The integrated cable modem and cable television management system includes a cable television server and an integrated cable modem and cable television that is operable to receive a broadcast signal or a digital signal from the cable television server. The integrated cable modem and cable television includes a cable modem that is operable to receive a signal from a cable television server via the Internet, a signal management circuitry that is operable to perform management of the broadcast signal or the digital signal, a signal storage circuitry that is operable to store the broadcast signal and the digital signal, and a signal retrieval and reproduction circuitry that is operable to perform display and transmission of the broadcast signal and the digital signal.

In certain embodiments of the invention, the cable modem, set top box, and the network attached storage management system is operable to receive the signal from the cable television server via any number of means including video-on-demand, offline video download, and streaming video. The cable modem, set top box, and networked attached storage management system are all built into the television set. The networked attached storage managed system stores the personal data and provides it on demand throughout a local networked system. The integrated cable modem and cable television management system is operable to perform time compression of the broadcast signal and the digital signal, and the time compression is performed within at least one of the cable television server and the integrated cable modem and cable television. The broadcast signal may be of any number of formats including a digital broadcast signal and an analog broadcast signal. The signal storage circuitry includes a hard drive in certain embodiments of the invention. The cable television server is operable to provide a cable television satellite broadcast service. The integrated cable modem and cable television management system also includes a signal management circuitry that is operable to perform scheduling and signal quality monitoring. The cable modem is communicatively coupled to the Internet via a connection wherein a portion of the connection comprises a wireless connection. The integrated cable modem and cable television management system also may include a media server network that is operable to perform link assessment of a link through which the cable modem receives the signal from the cable television server. The media server network may also include an adaptive media server network that is operable to perform local media storage on a server when the media includes high demand media. The media server network may be an adaptive media server network that is operable to transfer media between servers when the media comprises infrequently demanded media. The integrated cable modem and cable television may include one or both of a vehicle media system and a portable media system.

Various other aspects of the present invention can be found in any number of devices and systems that perform communication, storage, and processing of audio and video media within, among, and between various media operable systems. These various media systems include vehicle media systems, portable media systems, and media networks that are all operable to perform transmission and receipt of media between and among them. The communication links between the various devices may be wireless or wireline, as desired in any given application. Moreover, portions of the communicative coupling between the various devices may include a portion of wireless connectivity whereas other portions of the communicative coupling may include wireline based communication. The invention allows for receipt of media using alternative communication links, that may be selected on a number of bases, including availability, cost, and quality of service for cost. Media may be received and stored on various devices in accordance with the invention and subsequently displayed or played back on the various devices.

A television for enabling a consumer to access the Internet and other content using a television that has a television digital, analog, or other tuner, a built in modem, built in cable box, and includes configuring the television to have plurality of television channels and at least one virtual channel. The Virtual channel can be a streaming service, such as Netflix, Amazon Prime Video, Disney+, and HULU. Alternatively the virtual channel can be defined as the televisions' internal memory.

In a preferred embodiment, content of the virtual channel is stored in memory storage units within the television. Alternatively, content of the virtual channel is stored in memory remote from the television. In any case, updates to virtual channels can be sent via a DSL, or via a cable modem line or other Internet or network connection, wired or wireless, or via a vertical blanking interval (VBI) of a television signal.

The presently preferred method can include receiving consumer input via a conventional television control device in response to a prompt in the vertical blanking interval (VBI) of a TV channel or in a virtual channel. Other input devices can be used. Using the input, a consumer profile is established. Using the consumer profile, the virtual channels are established or updated. The input can be received and stored in memory inside the television at a first time, and then transmitted to a site remote from the television at a second time.

In another aspect, a method for presenting television signals and Web pages on a single interactive television (ITV) includes detecting television signals at a television tuner supported on the ITV. In response to a user channel selection, a television channel or a Web page is presented on the ITV, with the Web page being associated with a virtual channel. The Web page that is associated with the virtual channel can be changed or updated, such that a first version of the Web page is displayed via the virtual channel at a first time, and a second version of the Web page is displayed via the virtual channel at a second time.

In yet another aspect, a method is disclosed for presenting TV channels and Web pages establishing virtual channels on an interactive TV (ITV). The method includes receiving consumer input via a conventional TV control device, and establishing virtual channels based on the consumer input. The method also includes displaying either a TV channel or a virtual channel based on a user channel selection.

In still another aspect, a method for presenting TV channels and Web pages that establish virtual channels on an interactive TV (ITV) includes receiving consumer data, and establishing a virtual channel based on the consumer data. Either a TV channel or a virtual channel is displayed based on a consumer channel selection.

Other aspects, advantages and novel features of the present invention will become apparent from the following detailed description of the invention when considered in conjunction with the accompanying drawings.

### BRIEF DESCRIPTION OF DRAWINGS

The present invention will become more fully understood from the detailed description given hereinbelow and the accompanying drawings which are given by way of illustration only, and thus are not limitative of the present invention, and wherein:

FIG. 1 is a block diagram of the operation of a television according to the current disclosure.

FIG. 2 a second block diagram for the operation of the system according to the current disclosure.

FIG. 3 is a read view of a television according to the current disclosure.

FIG. 4A is a front view of a television according to the current disclosure.

FIG. 4B is a right side view of a television according to the current disclosure.

FIG. 4C is a left side view of a television according to the current disclosure.

### DESCRIPTION OF THE PREFERRED EMBODIMENTS

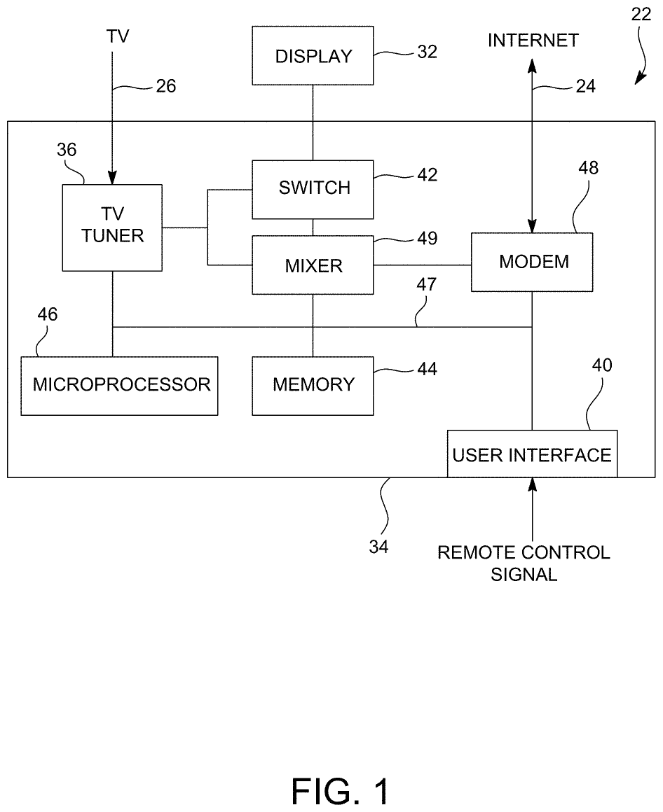

As shown in FIG. 1, the ITV 22 includes a housing 34 that holds a conventional television tuner 36. The TV tuner 36 receives the TV signals 26 and outputs them to a two-position switch 42, which in turn is controlled by a user interface 40 to output a consumer-selected TV channel (in a first position) or virtual channel (in a second position) to the display 32 of the ITV 22. It is to be understood that the user interface 40 can include an infrared receiver or other receiver for sensing remote control signals from the remote control 30. Also, the user interface 40 can include a visual portion, such as but not limited to a cursor that can be moved, by means of the remote control 30, across an electronic channel guide, Web page icon, and so on that are presented on the display 32, to enable a consumer to select a channel for display.

As mentioned above, not only can a consumer select a TV channel, but a virtual channel as well. In accordance with the present invention, a “virtual channel” is not a TV channel per se, but rather a Web-based channel that can be stored in a memory or other data storage 44 in the housing 34. That is, the memory or other data storage 44 can be computer memory, or a hard disk drive, optical drive, solid state storage, tape drive, or any other suitable data storage medium. The memory of the system and/or television can be internal to the television or it can be an integrated or entirely separate NAS (network attached storage system), having integrated hardware to provide a UI for personal media stored on replaceable hard drives. This hardware can optimize the stored data for different devices like mobile phones by transcoding.

The key features of this design is that all these systems: TV tuner/set top box, cable modem, network attached storage are built right into the TV, thus reducing the cable clutter and carbon footprint.

A microprocessor 46 is also supported in the housing 34 to execute the logic steps set forth below, with the microprocessor 46, memory 44, TV tuner 36, and switch 42 all being accessible via an internal data bus 47. The microprocessor 46 assigns channel numbers to virtual channels or otherwise maintains a table of channel numbers versus TV channels and virtual channels. Accordingly, when, for instance, an electronic channel guide is displayed on the display 32 of the ITV 22, the virtual channels are listed, typically at the end of the guide after the conventional TV channels, by channel number and by name.

Alternatively, the virtual channels can be stored in a location remote from the ITV 22, e.g., they can be stored at the ITV system server 18, for display of the channels (upon consumer selection thereof) real-time via the Internet (or other network) when data transfer rates are sufficiently high to support such real-time transfer. In any case, the ITV 22 includes a modem 48 that communicates with the Internet 24. The modem 48 can be a cable modem, conventional twisted pair wire modem, DSL, wireless modem, or other appropriate communication device. It is to be understood that a single high data rate cable (e.g., either wire or optical fiber) can be provided to carry both Internet data and TV signals.

In any case, the modem 48 outputs a signal to a mixer 49, which can mix the Web-based signal from the modem 48 with related signals from the TV tuner 36. For instance, if a virtual channel of a cable newscast is selected, the Web-based content can be combined with an actual broadcast newscast from the associated news station for simultaneous display of the newscast in a window of the virtual channel. The signal from the mixer 49 is sent to the switch 42 and thence to the display 32 when the user selects a virtual channel. The mixer 49 can be established by a chip made by and known means. As mentioned above, one or more of the microprocessor 46, memory 44, modem 48, mixer 49, and switch 42 can be housed in a set-top box that is electrically connected to a separate television housing which includes the tuner 36 and display 32.

It may now be appreciated that the microprocessor 46 controls the functions of the ITV 22 in accordance with the logic below. The flow charts herein illustrate the structure of the logic modules of the present invention as embodied in computer program software. Those skilled in the art will appreciate that the flow charts illustrate the structures of logic elements, such as computer program code elements or electronic logic circuits, that function according to this invention. Manifestly, the invention is practiced in its essential embodiment by a machine component that renders the logic elements in a form that instructs a digital processing apparatus (that is, a computer or microprocessor) to perform a sequence of function steps corresponding to those shown. Internal logic could be as simple as a state machine.

In other words, the present logic may be established as a computer program that is executed by a processor within, e.g., the present microprocessors/servers as a series of computer-executable instructions. In addition to residing on hard disk drives, these instructions may reside, for example, in RAM of the appropriate computer, or the instructions may be stored on magnetic tape, electronic read-only memory, or other appropriate data storage device.

The current apparatus may include a network apparatus storage system and may include removable/replaceable memory storage devices.

In regards to the processing systems of the disclosed apparatus, a “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

While embodiments herein may be discussed in terms of a processor having a certain number of bit instructions/data, those skilled in the art will know others that may be suitable such as 16 bits, 32 bits, 64 bits, 128 s or 256 bit processors or processing, which can usually alternatively be used. Where a specified logical sense is used, the opposite logical sense is also intended to be encompassed.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Intexhaust gas recirculating ation Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, removable media, flash memory, a “memory stick”, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, and any cellular network.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Additionally, the phrase “configured to” or “operable for” can include generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., intexhaust gas recirculating rated circuits) that are adapted to implement or perform one or more tasks.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

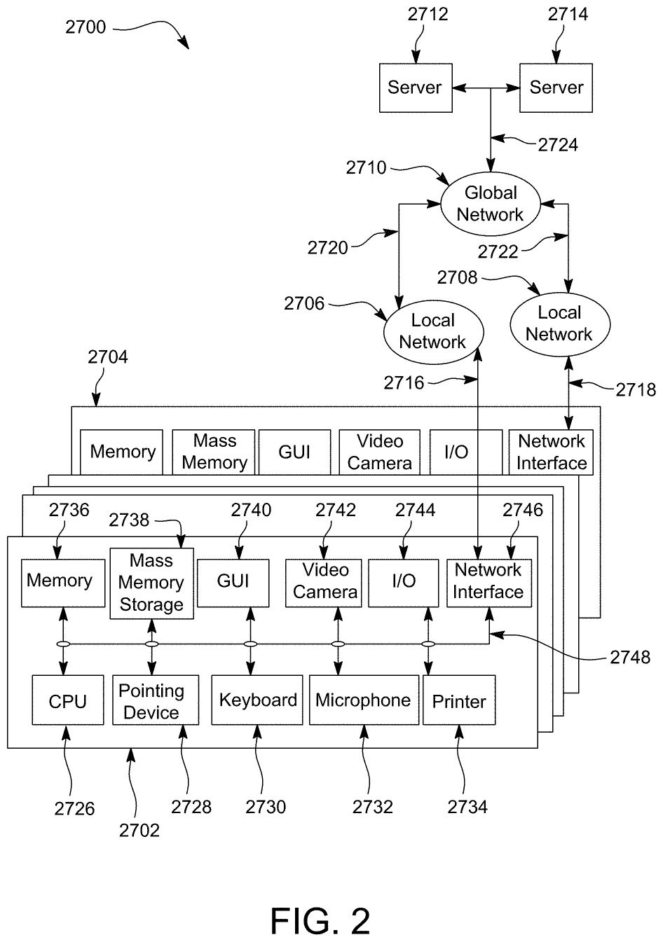

FIG. 2 is a block diagram depicting an exemplary client/server system which may be used by an exemplary web-enabled/networked embodiment of the present invention.

A communication system 2700 includes a multiplicity of clients with a sampling of clients denoted as a client 2702 and a client 2704, a multiplicity of local networks with a sampling of networks denoted as a local network 2706 and a local network 2708, a global network 2710 and a multiplicity of servers with a sampling of servers denoted as a server 2712 and a server 2714.

Client 2702 may communicate bi-directionally with local network 2706 via a communication channel 2716. Client 2704 may communicate bi-directionally with local network 2708 via a communication channel 2718. Local network 2706 may communicate bi-directionally with global network 2710 via a communication channel 2720. Local network 2708 may communicate bi-directionally with global network 2710 via a communication channel 2722. Global network 2710 may communicate bi-directionally with server 2712 and server 2714 via a communication channel 2724. Server 2712 and server 2714 may communicate bi-directionally with each other via communication channel 2724. Furthermore, clients 2702, 2704, local networks 2706, 2708, global network 2710 and servers 2712, 2714 may each communicate bi-directionally with each other.

In one embodiment, global network 2710 may operate as the Internet. It will be understood by those skilled in the art that communication system 2700 may take many different forms. Non-limiting examples of forms for communication system 2700 include local area networks (LANs), wide area networks (WANs), wired telephone networks, wireless networks, or any other network supporting data communication between respective entities.

Clients 2702 and 2704 may take many different forms. Non-limiting examples of clients 2702 and 2704 include personal computers, personal digital assistants (PDAs), cellular phones and smartphones.

Client 2702 includes a CPU 2726, a pointing device 2728, a keyboard 2730, a microphone 2732, a printer 2734, a memory 2736, a mass memory storage 2738, a GUI 2740, a video camera 2742, an input/output interface 2744 and a network interface 2746.

CPU 2726, pointing device 2728, keyboard 2730, microphone 2732, printer 2734, memory 2736, mass memory storage 2738, GUI 2740, video camera 2742, input/output interface 2744 and network interface 2746 may communicate in a unidirectional manner or a bi-directional manner with each other via a communication channel 2748. Communication channel 2748 may be configured as a single communication channel or a multiplicity of communication channels.

CPU 2726 may be comprised of a single processor or multiple processors. CPU 2726 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Intexhaust gas recirculating ated Circuits) or general purpose microprocessors.

As is well known in the art, memory 2736 is used typically to transfer data and instructions to CPU 2726 in a bi-directional manner. Memory 2736, as discussed previously, may include any suitable computer-readable media, intended for data storage, such as those described above excluding any wired or wireless transmissions unless specifically noted. Mass memory storage 2738 may also be coupled bi-directionally to CPU 2726 and provides additional data storage capacity and may include any of the computer-readable media described above. Mass memory storage 2738 may be used to store programs, data and the like and is typically a secondary storage medium such as a hard disk. It will be appreciated that the information retained within mass memory storage 2738, may, in appropriate cases, be incorporated in standard fashion as part of memory 2736 as virtual memory.

CPU 2726 may be coupled to GUI 2740. GUI 2740 enables a user to view the operation of computer operating system and software. CPU 2726 may be coupled to pointing device 2728. Non-limiting examples of pointing device 2728 include computer mouse, trackball and touchpad. Pointing device 2728 enables a user with the capability to maneuver a computer cursor about the viewing area of GUI 2740 and select areas or features in the viewing area of GUI 2740. CPU 2726 may be coupled to keyboard 2730. Keyboard 2730 enables a user with the capability to input alphanumeric textual information to CPU 2726. CPU 2726 may be coupled to microphone 2732. Microphone 2732 enables audio produced by a user to be recorded, processed and communicated by CPU 2726. CPU 2726 may be connected to printer 2734. Printer 2734 enables a user with the capability to print information to a sheet of paper. CPU 2726 may be connected to video camera 2742. Video camera 2742 enables video produced or captured by user to be recorded, processed and communicated by CPU 2726.

CPU 2726 may also be coupled to input/output interface 2744 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 2726 optionally may be coupled to network interface 2746 which enables communication with an external device such as a database or a computer or telecommunications or internet network using an external connection shown generally as communication channel 2716, which may be implemented as a hardwired or wireless communications link using suitable conventional technologies. With such a connection, CPU 2726 might receive information from the network, or might output information to a network in the course of performing the method steps described in the teachings of the present invention.

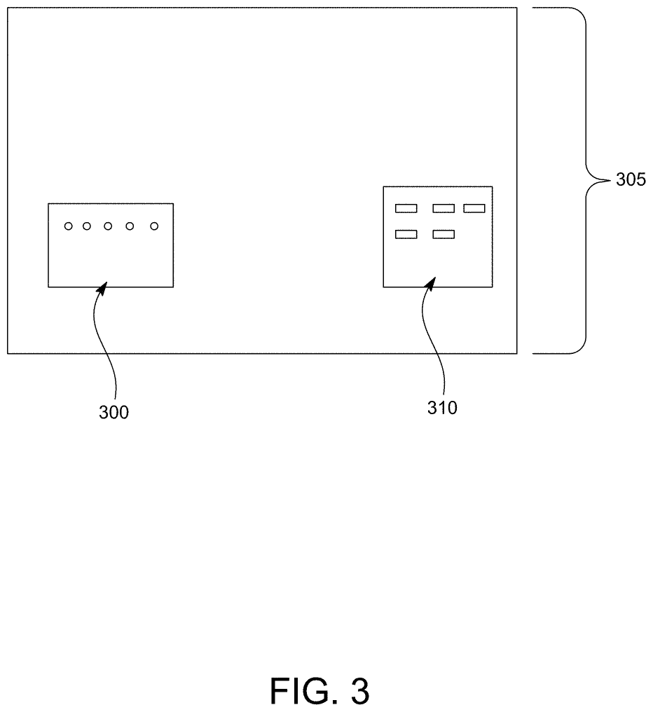

FIG. 3 is a perspective view of the back of the television, 305, according to the current disclosure. FIG. 3 shows the cable modem input, 300, and the television inputs, 310, for other devices via coaxial cables, USB inputs, etc.

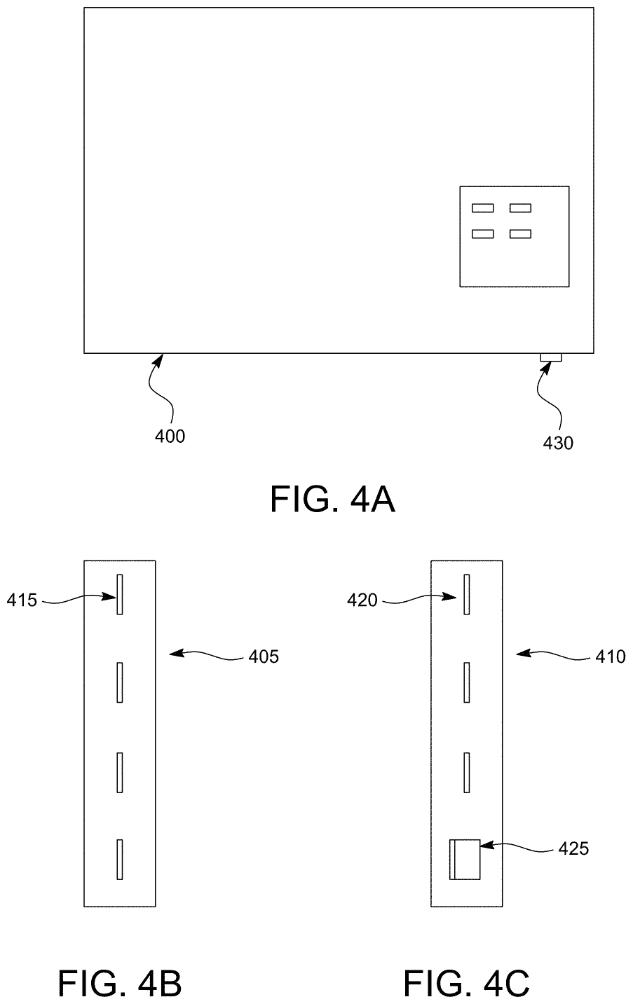

FIGS. 4A-4C show the front and sides of the television according to the current disclosure. FIG. 4A shows the front display, 400, of the television with a sensor, 430, for remote operation of the television. FIGS. 4B and 4C show the right and left sides of the television respectively. FIG. 4B shows the right side, 405, with a plurality of slots, 415, that are used to place removable hard drives into the TV. FIG. 4C shows the left side, 410, of the television, that has a plurality of input slots for USB, 420, cable modems, 425, and other slots that can be used for alternative input means.

1. An image display system comprising:
an image and sound reproducing apparatus that receives and reproduces a virtual channel from at least one of an internal source and an external source,
wherein the virtual channel comprises images and sounds; and
an update receiving component configured to receive updates to the virtual channel.

2. The image display system according to claim 1, wherein the external source is from a networked memory storage system.

3. The image display system according to claim 1, wherein the external source is a signal received by a cable modem internal to the image and sound reproducing apparatus.

4. The image display system according to claim 1, wherein
the image and sound reproducing apparatus comprises a system to reproduce the images and sounds stored on a memory storage device located within the image and sound reproducing apparatus

5. The image display system according to claim 1, wherein
the image and sound reproducing apparatus comprises a system to reproduce the images and sounds received by the image and sound reproducing apparatus from the external source.

6. The image display system according to claim 1, wherein
updates to the at least one virtual channel are sent, at least in part, via a DSL

7. The image display system according to claim 1, wherein
updates to the at least one virtual channel are sent, at least in part, via a cable modem line.

8. The image display system according to claim 1, wherein
updates to the at least one virtual channel are sent, at least in part, via a vertical blanking interval (VBI) of a television signal.
